(19) United States
(12) Patent Application Publication
(10) Pub. No.: US 2020/0223034 A1
(43) Pub. Date: Jul. 16, 2020

(54) POSITIONING AND CLAMPING SYSTEM AND METHOD

(71) Applicant: KUKA Systems GmbH, Augsburg (DE)

(72) Inventors: Per-Olaf Brockhoff, Friedberg/Stätzling (DE); Christian Karmann, Pöttmes (DE); Johann Kraus, Mertingen (DE)

(73) Assignee: KUKA Systems GmbH, Augsburg (DE)

(21) Appl. No.: 16/641,855

(22) PCT Filed: Aug. 16, 2018
(86) PCT No.: PCT/EP2018/072182

§ 371 Date: Mar. 31, 2020

(30) Foreign Application Priority Data
Aug. 25, 2017 (DE) 10 2017 119 489.4

(51) Int. Cl. B25B 11/02; B25J 15/00

(52) U.S. Cl. CPC B25B 11/02; B25J 15/0095; B25J 15/0061

(57) ABSTRACT

A positioning and clamping system for a workpiece to be processed, which is disposed at a work station on a mobile load receiver. The positioning and clamping system includes a mobile and robot-guided gripper tool for the workpiece, in particular a geo-gripper tool, for clamping the workpiece in a defined position and orientation. A stationary, adjustable support device supports, stabilizes, and positions the gripper tool, in particular the geo-gripper tool, at the work station in a stationary manner, together with the gripped, in particular clamped, workpiece for processing.

### CROSS-REFERENCE TO RELATED APPLICATIONS

This application is a national phase application under 35 U.S.C. § 371 of International Patent Application No. PCT/EP2018/072182, filed Aug. 16, 2018 (pending), which claims the benefit of priority to German Patent Application No. DE 10 2017 119 489.4, filed Aug. 25, 2017, the disclosures of which are incorporated by reference herein in their entirety.

### TECHNICAL FIELD

The invention relates to a positioning and clamping system, and to a method of manufacturing using the positioning and clamping system.

### BACKGROUND

Robot-guided geo-gripper tools for clamping workpieces in a defined position and orientation are known from practice, wherein a handling robot holds the geo-gripper tool in a suspended manner and presents it to joining robots for processing. In another embodiment known from practice, a handling robot guides a simple gripper tool, which is used to hold and deposit a workpiece onto a stationary clamping device for processing, in particular for joining.

It is the object of the present invention to provide an improved positioning and clamping technology and manufacturing technology.

### SUMMARY

The invention achieves this object by a positioning and clamping system as described herein.

The claimed positioning, clamping and manufacturing technology, in particular the positioning and clamping system, the manufacturing device and the manufacturing method have a variety of advantages.

The claimed positioning and clamping technology comprises a mobile and robot-guided gripper tool, and an adjustable support device for the gripper tool. The gripper tool can grip and hold the one-piece or multi-piece workpiece. In a simple form, the gripper tool may only be used to hold the workpiece, wherein the workpiece position and orientation can be relatively imprecise. For this purpose, the tool can comprise vacuum or clamping grippers, for example.

The gripper tool can also be designed as a more upscale geo-gripper tool, which is additionally used to clamp the workpiece in a defined position and orientation. The clamped workpiece can thus assume a predefined position and orientation on the geo-gripper tool with high geometric precision. The position and orientation may relate to the location and/or orientation of the workpiece.

The adjustable support device can support, stabilize and exactly position the gripper tool, in particular the geo-gripper tool, at the work station in a stationary manner, together with the clamped workpiece for processing the same. The support device can additionally fix the gripper tool, in particular the geo-gripper tool, in the bearing position. Using the gripper tool, in particular the geo-gripper tool, the workpiece that has been clamped in a defined position and orientation can also be exactly positioned and supported and, if necessary, fixed.

For the stabilization function, it is advantageous when the gripper tool is borne on several, preferably peripheral, contact points that are disposed at a distance from one another, and when a form-locked bearing engagement is achieved. Preferably, three, four or more contact points are present. The support device can comprise multiple retainers in a suitable design for this purpose, preferably in the form of controllable clamping grippers.

In the operating position, the gripper tool, in particular the geo-gripper tool, can thus be arranged and exactly positioned at the work station with high accuracy in terms of the position and orientation and mechanical stability. The loads and clamping forces can be borne in a stationary manner, preferably on the bottom, and with high rigidity. Thanks to the external stabilization by the support device, the gripper tool, in particular the geo-gripper tool, can have a lean and lightweight design that allows deformation. Due to the weight savings, the handling robot can have a low payload capacity and/or the workpiece weight can be increased.

On the other hand, a load receiving means can be relieved of clamping functions and of workpiece processing. It only has to hold the workpiece for transport purposes and possibly with reduced precision in terms of the position and orientation, and allow the workpiece to be picked up and possibly assembled by the gripper tool, in particular the geo-gripper tool. The load receiving means can therefore have a simplified and lightweight design. The weight savings benefits the material transport technology, in particular when using lightweight and battery-operated transport means.

The workpiece can have a one-piece or multi-piece design. A multi-piece workpiece can be positioned and held on the mobile load receiving means in the existing position and orientation. As an alternative, during an assembly operation in which the positions and orientations of existing workpiece parts are varied and/or additional workpiece parts are supplied, it can be positioned and clamped on the load receiving means.

The adjustable support device is preferably arranged at the work station in a stationary manner. It can assume an extended operating position at the work station for the bearing function thereof, and a retracted idle position. The adjustable support device has a small interference contour and does not impede the access to the workpiece when the support device does not yet perform its function. As a result of the adjustability, the support device can be retracted from the work station and the operating position into the idle position, thereby improving the accessibility to the workpiece. This is advantageous for the workpiece being received by the load receiving means by way of the robot-guided gripper tool, in particular geo-gripper tool. In addition, one or more further workpieces can be supplied to the work station as needed, such as by way of another load receiving means. In addition, the processing device can carry out preparatory processes on the workpiece and at the work station.

On the other hand, the adjustability of the support device facilitates the use of different geo-gripper tools, which are adapted to different workpieces. The different geo-gripper tools can have different shapes and/or sizes. The positioning and clamping system can comprise two or more different geo-gripper tools. The adjustable support device can be adapted to the different geo-gripper tools and can support and position each of these, thanks to the adjustability.

The adjustability of the support device can take place in multiple control axes or directions. A lateral, in particular horizontal, adjustment enables the movement between the operating position and the idle position. An additional height adjustment allows the position and orientation in terms of the height to be varied and, if necessary, also allows oblique positioning of the supported geo-gripper tool.

The geo-gripper tool can be guided by a handling robot, in particular a multi-axis industrial robot, and be fed, and possibly transferred, to the adjustable support device. The geo-gripper tool can comprise a suitable connection for this purpose, for the possibly detachable and media-transmitting connection to the handling robot.

The geo-gripper tool comprises a support means including clamping means for the workpiece and including the aforementioned connection for a handling robot, and including positioning means for a form-locked bearing engagement with the retainers in a defined position and orientation. The preferably three, four or more contact points for the support device can be situated on the tool periphery, in particular on laterally projecting protrusions.

Different options exist for configuring the geo-gripper tool. A design as a support frame including multiple connected support bars is particularly favorable. These can have a predefined, in particular prismatic, outer contour, which facilitates form-locked receiving, positioning and bearing by the support device. As an alternative, tubular bars having a different outer contour can preferably be used. Perforating the support bars facilitates the attachment of the positioning means, such as in the form of pins, on the support bars and the contact points preferably formed here. As an alternative, the support means can have a different configuration, such as a plate form.

The geo-gripper tool is preferably placed from above onto the support device, and is positioned and supported and, if necessary, fixed in the process. The support device can be designed in an arbitrarily suitable manner for this function.

In the borne position, the gripper tool, in particular the geo-gripper tool, is preferably positioned in such a way that the workpiece hangs on the bottom side thereof and is processed in this position and orientation. As an alternative, the gripper tool, in particular the geo-gripper tool, can be turned, wherein the workpiece is disposed on the top side. The hanging workpiece arrangement has time and space advantages. The workpiece on the load receiving means can be gripped from above by way of the gripper tool, in particular the geo-gripper tool, and clamped, if necessary, and raised in this position and orientation until the support device is able to assume the extended operating position thereof, and then can be lowered again for bearing purposes. This sequence of motions is fast, has only short distances, and requires little clearance. The process time within a work cycle can be better utilized.

In an advantageous embodiment, the support device comprises multiple bearing means, which are disposed at a distance from one another and distributed across an area and which each include a retainer for the geo-gripper tool which can be adjusted in one axis or multiple axes. The bearing means can be present in any arbitrary suitable number and arrangement. An arrangement of four bearing means that are distributed in a square and disposed at a lateral distance from the work station or the load receiving means situated there is favorable. An arrangement, and optionally oblique orientation, of the bearing means in the corner regions of the work station or of the load receiving means is advantageous.

The bearing means can have a gallows-like design. They can comprise an upright post including a horizontal boom arm and a single-axis or multi-axis actuator for the retainer. The actuator can move the boom arm, functioning as a support arm, together with the preferably terminal retainer, laterally, and optionally vertically, relative to the post. The actuator can comprise one or more translatory and/or rotatory control axes. For example, a linear translatory axis is favorable.

The positioning and clamping system can comprise a controller. It may also be automatically adjustable. During a tool change, the controller can receive a corresponding piece of control information or a control command from a higher-level station or machine controller. The support device can be appropriately controlled for supporting and positioning the associated geo-gripper tool and accordingly position the one or more retainers for the geo-gripper tool.

The positioning and clamping system and the associated positioning and clamping method can form a technologically and economically self-contained unit. They can be disposed on an existing manufacturing device by retrofit or retooling. As an alternative, they can be part of the original equipment of a manufacturing device.

The handling robot for guiding and feeding the geo-gripper tool can be an integral part of the positioning and clamping system. As an alternative, a handling robot that is already present in a manufacturing device can be used and configured for this purpose. The controller of the positioning and clamping system can be implemented in the robot controller of the handling robot.

The manufacturing device can comprise the aforementioned work station. It can furthermore comprise a positioning device, by which the load receiving means is positioned in a defined position and orientation at the work station. In this way, the load receiving means can be positioned directly. As an alternative or in addition, the load receiving means can be positioned indirectly by way of a transport means, which transports the load receiving means, together with the workpiece.

A detachable connection between the load receiving means and the transport means is also advantageous. The preferably frame-like load receiving means can be detached from the transport means by the positioning device for the intended manufacturing process, and be positioned independently. The released transport means can then continue to move independently.

Arbitrary processing operations can be carried out on the workpiece. Advantageously, these are joining process, and possibly also assembly processes.

The manufacturing device and the manufacturing method can be an integral part of a manufacturing system and of a cross-system manufacturing process. The transport means is advantageously designed as a driverless and automatically controllable as well as preferably floor-bound transport vehicle, such as an AGV. It can be moved on a cross-system network of transport paths. It can travel on such a transport path into a manufacturing device, designed as a manufacturing cell, for example, to an interior work station.

Further advantageous embodiments of the invention will be apparent from the accompanying drawings and the description thereof.

The invention is shown schematically by way of example in the drawings.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 shows a purely schematic drawing of a manufacturing device comprising a positioning and clamping system;

FIG. 2 shows a perspective view of the manufacturing device comprising a workpiece on a load receiving means and a processing device;

FIG. 3 shows the arrangement from FIG. 2, together with the positioning and clamping system;

FIG. 4 shows a perspective view of the positioning and clamping system;

FIGS. 5 and 6 show a side view and a top view of the positioning and clamping system according to FIG. 4; and

FIG. 7 shows a cutaway and enlarged perspective view of a geo-gripper tool of the positioning and clamping system.

### DETAILED DESCRIPTION

The invention relates to a positioning and clamping system (5) and to an associated method for a workpiece (3). The invention furthermore relates to a manufacturing device (2) comprising the positioning and clamping system (5), in addition to a manufacturing method. The invention furthermore encompasses a manufacturing system (1) and a cross-system manufacturing process.

The workpiece (3) can have a one-piece or multi-piece design. The workpiece (3) can be of any arbitrary kind and size and can be made of any arbitrary material, such as metal and/or plastic. Preferably, it is a component of a vehicle body made of metal and/or plastic. In a preferred embodiment, the workpiece (3) is designed as a parts set made of multiple workpiece parts, in particular car body parts.

The workpiece (3) is positioned and clamped in a specified and defined position and orientation at a work station (25) by way of the positioning and clamping system (5). It can then be subjected to a one-stage or multi-stage processing operation, such as a joining process. The drawings illustrate a joining process in the form of a welding process, which is carried out by a processing device (4) comprising welding tools. The processing device (4) comprises, for example, one or more multi-axis industrial robots (27), which are designed as joining robots, in particular welding robots, and which support and guide a joining tool, in particular a welding tool.

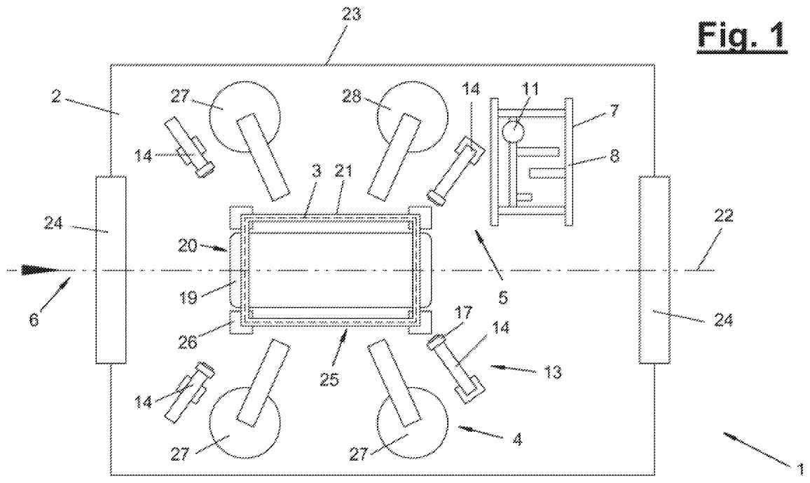

FIG. 1 shows a schematic top view of a manufacturing device (2) comprising a positioning and clamping system (5) for positioning and clamping a schematically illustrated workpiece (3), shown with dotted lines, at a work station (25). The work station (25) can be present once or multiple times and is preferably located in the interior of the manufacturing device (2). The manufacturing device (2) is designed as a manufacturing cell, for example. It can be surrounded by a protective partition (23), such as a fence.

It is possible for multiple manufacturing devices (2) to be present in a manufacturing system (1) and to be connected to one another by a schematically indicated transport device (6). The transport device (6) can comprise a branched network of transport paths (22) on which the workpieces (3) are transported. A transport path (22) can extend into or through the manufacturing device (2), and optionally through one or more air locks (24) in the protective partition (23).

The workpiece (3) is supplied to the manufacturing device (2) and the work station (25) on a load receiving means or component bearing means (21). The load receiving means (21) is referred to hereafter in abbreviated form as LAM.

The LAM (21) preferably has a frame-like design and receives the workpiece (3), in particular the parts set, in a predefined position and orientation using appropriate holders. The LAM (21) has a substantially rectangular and flat shape, for example. FIG. 1 schematically shows the LAM (21) in the form of a rectangular frame.

The workpiece (3) can be removed from the LAM (21) by way of the positioning and clamping system and be positioned and clamped in a stable position and orientation that is appropriate for manufacturing, in particular appropriate for joining. Potentially loose parts of the workpiece (3) can be gripped and brought into a defined relative position with respect to one another, and be clamped for the joining process. Moreover, additional workpieces or workpiece parts can be supplied from outside and likewise be positioned and clamped.

The LAM (21) is fixedly, or preferably detachably, disposed on a transport means (19). It is transported by the transport means (19) on the transport path (22) into the manufacturing device (2) and to the work station (25) located inside. A positioning device (26) positions the LAM (21), and thus the workpiece (3), in a predefined position and can also ensure fixation in this position.

The transport means (19) is preferably designed as a driverless and automatically controlled, steerable and preferably floor-bound vehicle, in particular as an AGV. The transport means (19) moves on the aforementioned network of transport paths (22). The transport device (6) comprises multiple transport means (19), which also connect the manufacturing device (2) to other system components, such as further manufacturing devices (2) and/or a provision for transport means (19) and/or LAM (21) and/or workpieces (3) or the like.

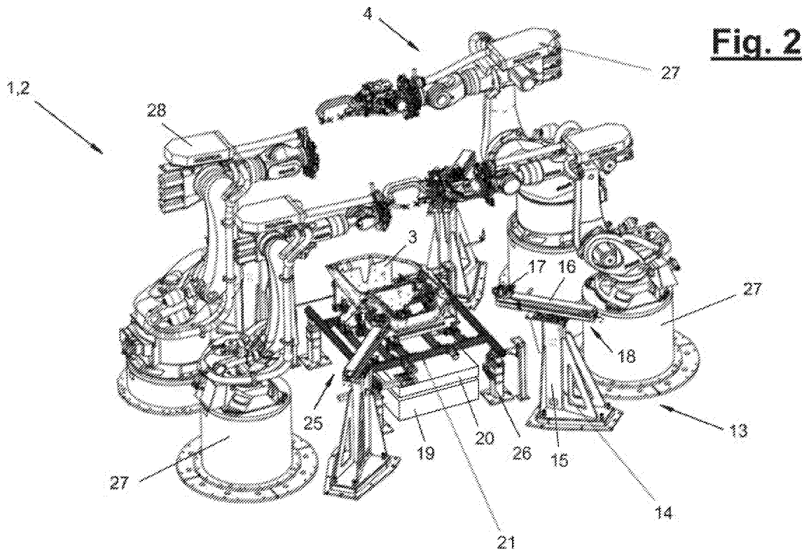

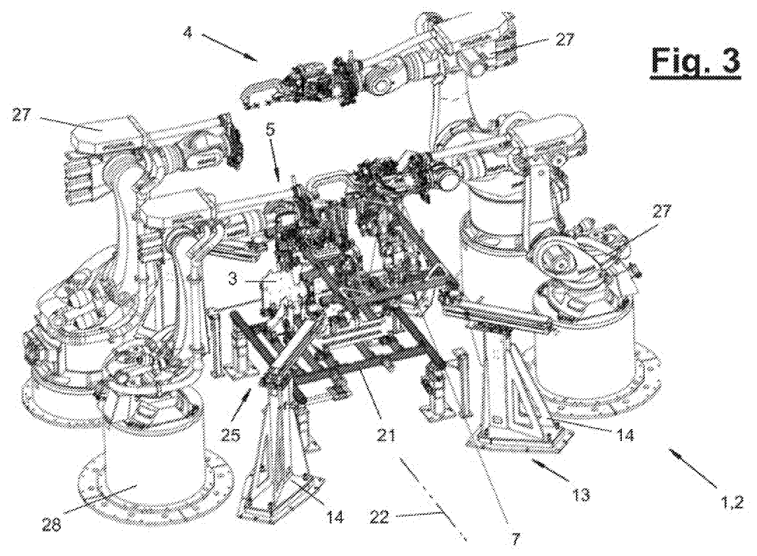

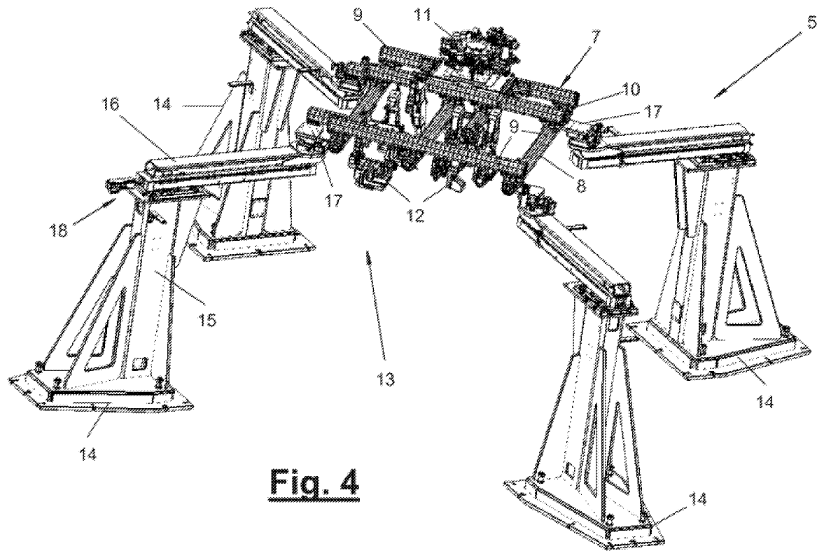

The transport means (19) comprises, for example, a chassis including an undercarriage and a lifting device (20), which receives the LAM (21) and is able to raise and lower the LAM (21). Such a lifting or lowering motion can be used to transfer the LAM (21) to the aforementioned positioning device (26) and to support and position it there. The transport means (19) can be detached from the LAM (21) in the process and can subsequently leave the manufacturing device (21). FIG. 2 schematically shows the transport means (19) comprising the lifting device (20) and the positioning device (26), which is formed here, for example, by multiple upright posts in the corner regions of the work station (25) or of the LAM (21).

The positioning and clamping system (5) comprises a mobile and feedable gripper tool (7) and an adjustable support device (13). The gripper tool (7) is designed as a geo-gripper tool (7), for example. It grips the workpiece (3) and is used to position and clamp the workpiece (3) in a defined position and orientation. The workpiece (3) is preferably removed from the LAM (21) in the process. In the case of the aforementioned parts set, the components can be consecutively removed from the LAM (21) and assembled, positioned appropriately for processing and clamped on the geo-gripper tool (7).

The gripper tool (7) is also referred to as a geometry gripper tool. The function thereof is to clamp the workpiece (3) in a precise, predefined position and orientation, in particular location and/or alignment or orientation. In this way, an exact relationship, in terms of the position and orientation, between the workpiece (3) and the geo-gripper tool (7) and the one or more reference points thereof is also established. In the case of a multi-piece workpiece (3), such as a parts set, the workpieces parts or components can each be brought into an exact, defined mutual relative position and orientation on the geo-gripper tool (7) when being clamped in a defined position and orientation. After processing, in particular joining, the multi-piece tool (3) has an exact, predefined geometry.

As an alternative, the gripper tool can have a simpler configuration, such as a vacuum gripper system, and can grip the workpiece (3) with less precision in terms of the position and orientation. The following explanations also apply accordingly to such a simpler gripper tool.

The function of the adjustable support device (13) is to support the geo-gripper tool (7) at the work station (25) in a stationary manner and to position it. The support device (13) can also stabilize, and possibly fix, the geo-gripper tool (7) in this position if needed. The clamped workpiece (3) is thus also supported in a stationary manner, positioned at the work station (25) and possibly fixed. For this purpose, the support device (13) comprises multiple retainers (17), which establish a preferably form-locked bearing engagement with the geo-gripper tool (7). The three, four or more retainers (17) of the support device (13) are distributed in multiple directions at a distance from one another.

The bearing engagement on the geo-gripper tool (7) takes place in multiple contact points spaced apart from one another. These are preferably disposed at the periphery of the geo-gripper tool (7) and in a distribution corresponding to the retainers (17). In this way, the geo-gripper tool (7) can be borne in a mechanically stable manner on three, four or more spatially distributed spots or contact points. One or more contact points can be the aforementioned reference points, or can have a defined relationship, in terms of the position and orientation, thereto.

The geo-gripper tool (7) can comprise positioning means (10) at the contact points, which define the specified position of the supported geo-gripper tool (7) at the work station (25) and secure the form-locked bearing engagement in conjunction with the particular retainer (17).

The retainers (17) can also have a fixation function for the received geo-gripper tool (7). For this purpose, these can be designed as controllable and driven clamping grippers, for example, in particular as zero point grippers.

The geo-gripper tool (7) is guided and fed by a handling robot (28) and transferred to the support device (13). The geo-gripper tool (7) is preferably placed from above onto the support device (13) in the process.

In the shown embodiment, the handling robot (28) is designed as a multi-axis industrial robot. The handling robot is preferably designed as an articulated arm robot or jointed-arm robot and preferably has five or more robot axes. These can be rotatory and/or translatory robot axes.

The geo-gripper tool (7) comprises a connection (11) for the handling robot (28). The handling robot (28) can comprise an automatic change-over coupling, which allows the handling robot (28) to be detached from the geo-gripper tool (7) and the tool to be replaced, and possibly also allows media to be transmitted. The handling robot (28) can remain connected to the supported geo-gripper tool (7) during the processing operation. As an alternative, it can pass the geo-gripper tool (7) on to the support device (13) and then de-couple.

In the shown embodiment, the geo-gripper tool (7) comprises a support means (8) comprising one or more clamping means (12) for the workpiece (3) and the aforementioned connection (11). It is possible for several of the clamping means (12) to be present. These can comprise form-locked and/or force-fit, such as clamping, gripping means and stops, centering pins or other position-providing means for the workpiece (3). For example, the clamping means (12) can be disposed so as to hang on the bottom side of the support means (8). The connection (11) can be located on the other side, for example, in particular the top side of the support means (8).

The support means (8) is designed as a support frame, for example, which is composed of multiple, mutually connected support bars (9). The support frame can have a substantially rectangular and flat shape. The preferably tubular support bars (9) have a prismatic outer contour, for example, and include a perforation in the jacket. The support bars (9) can be oriented in a cross-like manner. The prismatic outer contour and the perforation facilitate a defined, and preferably form-locked, connection between the support means (8) and the support device (13) and the one or more retainers (17) thereof. As an alternative, the outer contour can be rounded, in particular can be oval.

The support means (8) can comprise stub-like protrusions or extensions of the support bars (9), which project laterally in several, for example four, locations on the tool periphery, and form the contact points for the form-locked bearing engagement with the particular retainer (17). The positioning means (10), which are formed by multiple pins, for example, which are inserted into the perforation there in a spatially distributed manner, are disposed at the contact points. The retainers (17) have matching counter-elements and establish a form-locked engagement with the positioning means (10).

The positioning and clamping system can comprise several different geo-gripper tools (7). These can be adapted to different workpieces (3). Accordingly, they can have different shapes and dimensions. The adjustable support device (13) allows a preferably automatic adaptation to these different geo-gripper tools (7).

A magazine (not shown) for several and different geo-gripper tools (7) can be present in the manufacturing device (2). During a workpiece change-over, the handling robot (28) can exchange the geo-gripper tool (7).

The geo-gripper tools (7) can be fed and removed with an adapted LAM. The support device (13) can be designed in an arbitrarily suitable manner. In the shown exemplary embodiment, it is formed by four bearing means (14), which are disposed at the work station (25) at a distance from one another and, for example, distributed in a square. The bearing means (14) are disposed, for example, in the corner regions of the work station (25) or of the LAM (21) positioned here. They are disposed at a distance outside the work station (25) and the positioning device (26). They can be moved, as needed, between a retracted idle position and an operating position in the vicinity of the LAM (21). In a modification of the shown embodiment, the number and arrangement of the bearing means (14) can vary. The left half of the image of FIG. 1 shows the retracted idle position, and the right half of the image shows the extended operating position.

The bearing means (14) are each equipped with a retainer (17) for the geo-gripper tool (7). The retainer (17) can be adjusted in one or more control axes by way of a actuator (18).

The retainers (17) can each be designed in the above-described manner for receiving the geo-gripper tool (7), in particular a support bar (9). The retainers (17) can each be selectively designed to be rigid or movable, in particular in the form of clamping grippers. The receiving shape thereof can be adapted to the outer contour, in particular to the prismatic jacket, of a support bar (9).

In another simple form, for example, each of the retainers (17) can be designed as a pan-shaped resting surface for a support bar (9) or another part of the geo-gripper tool (7). They can reach into the perforation by way of a mandrel or the like, for example, for positioning and locking purposes.

In the shown embodiment, each of the bearing means (14) is stationary and disposed so as to stand on the floor. They are designed in the manner of a gallows, for example, and are identical. They each comprise an upright post (15) that is fixed to the floor and includes a horizontal boom arm (16) projecting transversely at the upper post end. This acts as a support arm for the retainer (17) disposed at the end and, preferably, on the top side of the boom arm (16).

In the shown embodiment, the posts (15) are disposed at a lateral distance from the work station (25) and in the corner regions thereof. The protruding boom arm (16) is oriented obliquely, in particular diagonally, with respect to the work station (25) and the LAM (21) located there. The bearing means (14) are disposed in the aforementioned corner regions and do not interfere with joining and handling robots (27, 28) disposed on the longitudinal sides of the work station (25) or the travel path (22) passing through.

The boom arms (16) are each disposed at such a, preferably identical, height above the floor that, in the operating position, the supported geo-gripper tool (7) and the workpiece (3) hanging thereon, for example, have sufficient downward clearance for the processing operations. The, for example rigid, post (15) can have a suitable length for this purpose. In this borne position and orientation, the main plane of the geo-gripper tool (7) can assume a lying, in particular horizontal, position.

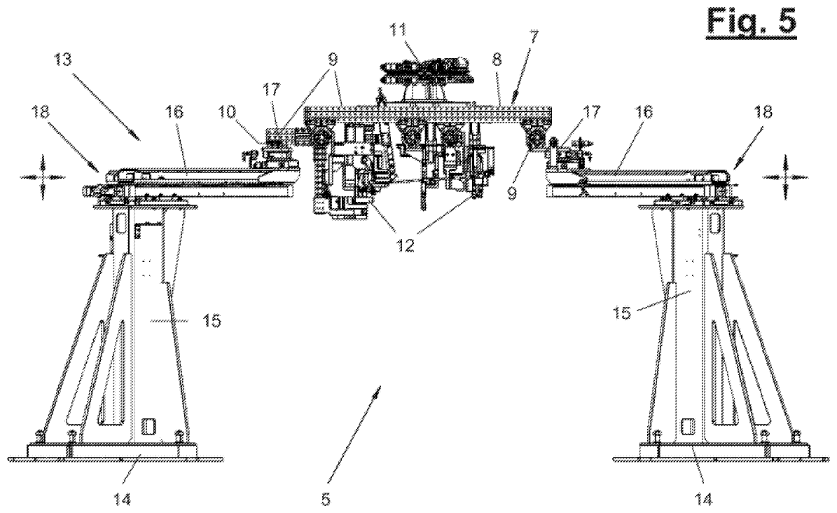

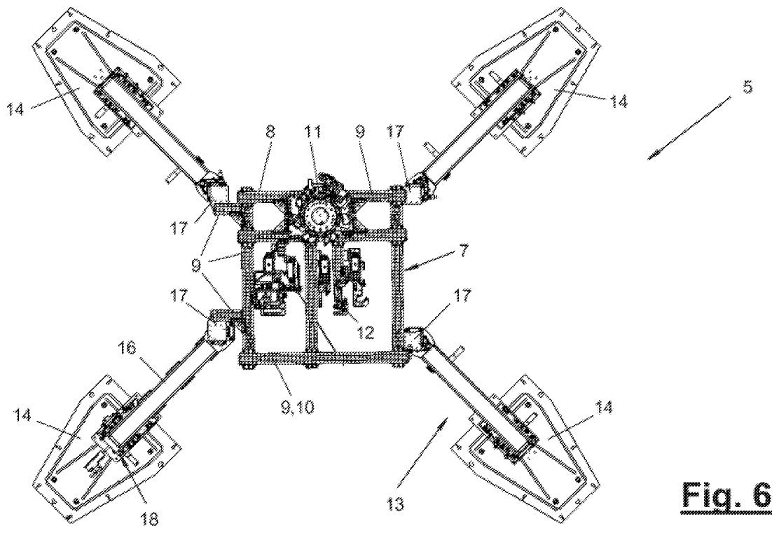

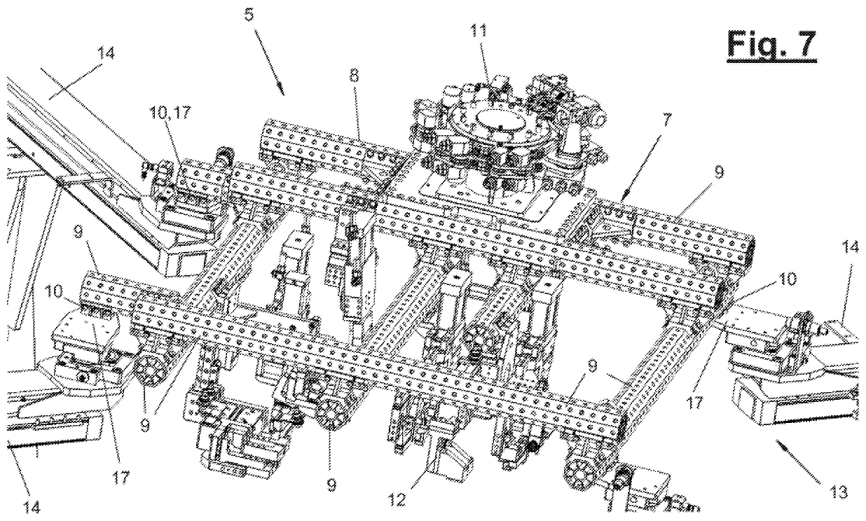

In addition, a single-axis or multi-axis actuator (18) is present for the respective boom arm (16). The actuator (18) can move the preferably straight boom arm (16) in one or more control axes relative to the post (15) according to the arrows in FIG. 5.

The respective boom arm (16) can be displaced by way of the actuator (18) in a translatory, and preferably linear, control axis along the longitudinal extension thereof, relative to the post (15), between the idle and operating positions. The direction of movement is horizontally oriented. In addition, it is directed obliquely, in particular diagonally, with respect to the work station (25).

The respective boom arm (16) can furthermore be upwardly displaced by way of the actuator (18) in a further translatory, preferably linear, and upright, in particular vertical, control axis relative to the post (15). The different boom arms (16) can be raised and/or lowered to the same extent and a different extent in the process. If the height is different, a corresponding oblique position of the geo-gripper tool (7) can be achieved. To avoid constraints, the retainers (17) can have corresponding degrees of freedom.

When the operating and borne position is assumed, the end position of the retainer (17) in the space can be determined by the shape and dimension of the particular geo-gripper tool (7).

In a modification of the shown exemplary embodiments, the bearing means (14) can have a rigid design, wherein the single-axis or multi-axis actuator (18) is disposed between the bearing means (14) and the floor. In another variant, different kinematics, in particular pivoting motions, of the boom arm (16) and/or the post (15) are possible.

The actuator (18) can comprise one or more of the aforementioned control axes. The control axes can be designed as translatory or rotatory control axes. In the shown embodiment having the linear adjustment of the boom arm (16), the actuator (18) has a linear guidance, for example, using a ball screw.

In addition, the retainers (17) can comprise one or more dedicated control axes. For example, they may be displaced in a linear manner on a compound slide, for example, in two, preferably horizontal, directions. The retainer (17) can furthermore carry out a rotational movement for an orientation with respect to the geo-gripper tool (7), in particular a support bar (9), which is suitable for receiving.

In the manner described above, the positioning and clamping system (5) can comprise several different geo-gripper tools (7) that are adapted to different workpieces (3). So as to adapt to the different geo-gripper tools (7), the support device (13) can be adjustable by way of the one or more actuators (18). Preferably, automatic adjustability is provided.

The positioning and clamping system (5) can comprise a controller (not shown). The controller can act, in particular, on the support device (13) and the one or more actuators (18) thereof. The controller can be independently designed and arranged. As an alternative, it may be integrated into an existing different controller, such as a robot controller of the handling robot (28). The one or more actuators (18) can be controlled, for example, as an additional axis of the handling robot.

The operation of the manufacturing device (2) and of the positioning and clamping system (5) can take place in the following manner, for example: A transport means (9) including a LAM (21) and a workpiece (3) travels on the transport path (22) through the one air lock (24) into the manufacturing device (2) and stops at the work station (25) located there. The LAM (21) is possibly picked up and positioned on the positioning device (26) by the lifting device (20) or in another manner. The transport means (19) can remain at the work station (25) or leave the manufacturing device (2) via the other air lock (24).

Using the change-over coupling, the handling robot (28) grips the geo-gripper tool (7) that matches and is required for the particular workpiece (3), and thereby picks up the workpiece (3), in particular one or more components of a parts set, from the LAM (21). The support device (13) is inactive or is in the retracted idle position, so that free access of the handling robot (28), and also of the processing device (4), to the work station (25) is ensured.

Using the robot-guided geo-gripper tool (7), parts or components of the workpiece (3) can be gripped individually or in groups, simultaneously or consecutively, and assembled, and positioned and clamped on the geo-gripper tool (7) in the position appropriate for processing.

Thereafter, the support device (13) assumes the operating position, wherein the handling robot (28) places the geo-gripper tool (7), together with the clamped workpiece (3), on the retainers (17) in the above-described manner, and supports and positions it. Thereafter, the processing device (4) can carry out one or more processing operations, wherein, for example, the joining robots (27) join, in particular weld, the clamped workpiece (3).

At the end of the processing operation, the handling robot (28) detaches the geo-gripper tool (7) from the support device (13), which thereupon returns to the idle position and provides access to the LAM (21).

In a first variant, the handling robot (28) set the processed workpiece (3) down on the original LAM (21), whereupon the workpiece is accepted by the transport means (19) again and subsequently transported out of the manufacturing device (2). In another variant, the LAM (21), after the workpiece (3) has been picked up by the handling robot (28) and the geo-gripper tool (7), can be removed from the manufacturing device (2), wherein subsequently a different LAM better suited for the processed workpiece (3) is delivered to the work station (25) by another transport means (19) and positioned here so as to accept the processed workpiece (3).

Intermediate steps or intermediate processes are also possible. Individual parts of components of the workpiece (3) can be picked up by a different handling robot using a different geo-gripper, held in a suspended manner, and be presented to the joining robots (27) for a first joining process, and subsequently be deposited onto the LAM (21) again. In this way, a prejoined assembly can be formed within the workpiece (3). This can subsequently be gripped, together with the other parts or components of the workpiece (3), by the robot-guided geo-gripper tool (7) in the above-described manner, clamped, and borne on the support device (13).

Furthermore, additional workpieces can be supplied to the work station (25). For this purpose, for example, the handling robot (28) can grip a first workpiece (3) from a first LAM (21) using the geo-gripper tool (7) and clamp it, and subsequently grip a second workpiece from a second LAM (21) and clamp it. For this purpose, a LAM change can be carried out in the interim at the work station (25). In a further modification, other workpieces or components can also be delivered into the manufacturing device (2) by a separate transport means.

Using the transport means (19) and a LAM, it is also possible to change workpiece-specific tools, in particular geo-gripper tools (7) of the type described above. A magazine for geo-gripper tools (7) can be dispensable in such a case, for example.

The manufacturing system (1) can comprise several of the described manufacturing devices (2). Using the transport device (6) and the transport means (19) and the LAM (21), the workpieces (3) can be transported further on the transport path network in a manufacturing flow between the manufacturing stations (2) and be transported in a loop to a provision (not shown) of workpieces (3) and/or LAM (21). Here, fully processed workpieces (3) can be unloaded, and new workpieces (3) to be processed can be loaded onto the LAM (21).

In the manufacturing system (1), the manufacturing devices (2) can be disposed in a preferably uniform matrix, including a surrounding transport path network. The manufacturing devices (2) can be identically designed among one another, wherein the adaptation thereof to the respective processing operations can take place in a workpiece-specific manner. Within the manufacturing system (1), a tryout station or a pilot station for a manufacturing device (2) can be present for this purpose, in which, during a workpiece change-over, an adaptation of the controller of the manufacturing device (2) or of the components thereof, in particular also of the processing device (4) and of the positioning and clamping system (5), is carried out. A corresponding data and control record can then be provided together with workpiece-specific tools to the different manufacturing devices (2). It is possible to retool the manufacturing system (1) during ongoing operation without significant interruptions.

Modifications of the shown and described exemplary embodiments are possible in a variety of ways. The features of the different exemplary embodiments and of the described variants can be arbitrarily combined with one another and possibly also exchanged.

A manufacturing device (2) can comprise a multiple arrangement of work stations (25), and possibly also multiple positioning and clamping systems (5). The support device (13) can comprise a different number and arrangement of bearing means. Instead of the shown floor-bound arrangement of the bearing means (14), a different, in particular hanging, arrangement may be present. Instead of several individual bearing means (14), the support device can comprise a combination design. The one or more bearing means (14) can have a different geometry and different kinematics. In another modification of the different embodiments, it is possible for multiple retainers (17) to be disposed rigidly, or also at least partially movably, on a bearing means (14). The different gripper tools, in particular geo-gripper tools (7), can have an accordingly adapted design for this purpose. Instead of the handling robot (28), a different multi-axis handling device can be used for the gripper tool, in particular the geo-gripper tool (7).

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE NUMERALS

1 manufacturing system
2 manufacturing device, manufacturing cell
3 workpiece
4 processing device
5 positioning and clamping system
6 transport device
7 gripper tool, geo-gripper tool
8 support means, support frame
9 support bar
10 positioning means
11 connection
12 clamping means
13 support device
14 bearing means
15 post
16 boom arm
17 retainer
18 actuator
19 transport means, AGV
20 lifting device
21 load receiving means, LAM
22 transport path
23 protective partition
24 air lock
25 work station, processing area
26 positioning device
27 joining robot
28 handling robot

What is claimed is:

1-17. (canceled)

18. A positioning and clamping system for a workpiece to be processed and which is arranged at a work station on a mobile load receiving means, the positioning and clamping system comprising:
at least one mobile and robot-guided gripper tool configured for engaging the workpiece; and
an adjustable support device configured to support, stabilize, and position the at least one gripper tool at the work station in a stationary manner, together with the gripped workpiece, for processing the workpiece.

19. The positioning and clamping system of claim 18, wherein the robot-guided gripper tool is a geo-gripper tool configured for clamping the workpiece in a defined position and orientation.

20. The positioning and clamping system of claim 18, wherein the support device is disposed in a stationary manner at the work station and is adjustable between an extended, operating position at the work station and a retracted, idle position.

21. The positioning and clamping system of claim 18, wherein:
the at least one robot-guided gripper tool comprises a plurality of different gripper tools, each adapted to engage different workpieces; and
the support device is adjustable to thereby adapt to the plurality of different gripper tools.

22. The positioning and clamping system of claim 18, wherein the support device comprises a plurality of retainers configured to establish a form-locked supporting engagement with the gripper tool on a plurality of contact points that are disposed at a distance from one another.

23. The positioning and clamping system of claim 22, wherein the plurality of retainers are controllable clamping grippers.

24. The positioning and clamping system of claim 18, wherein the at least one gripper tool comprises:
a support means;
clamping means coupled with the support means and configured for engaging the workpiece;
a connection coupled with the support means and configured for coupling the gripper tool with a handling robot; and
positioning means coupled with the support means and configured for a form-locked supporting engagement with the support device in a defined position and orientation.

25. The positioning and clamping system of claim 24, wherein the support means is configured as a flat support frame comprising a plurality of connected support bars.

26. The positioning and clamping system of claim 18, wherein the support device comprises a plurality of bearing means disposed at a distance from one another and distributed across an area, each of the bearing means including a retainer configured to establish a form-locked supporting engagement with the gripper tool, and a single-axis or multi-axis actuator.

27. The positioning and clamping system of claim 26, wherein the support device comprises four bearing means distributed in a square arrangement and disposed at a lateral distance from the work station.

28. The positioning and clamping system of claim 26, wherein the bearing means each comprise:
an upright post;
an adjustable, laterally projecting boom arm extending from the post; and
one of the retainers at an end the boom arm.

29. A manufacturing device for workpieces to be processed and which are disposed at a work station on a mobile load receiving means, the manufacturing device comprising a positioning and clamping system according to claim 18.

30. The manufacturing device of claim 29, further comprising:
a processing device configured for processing the workpiece; and
a handling robot for the gripper tool, which each comprise at least one multi-axis industrial robot.

31. The manufacturing device of claim 29, further comprising a positioning device proximate the work station and configured for positioning at least one of:
the load receiving means; or
a transport means configured for transporting the load receiving means.

32. A method for processing a workpiece, which is supplied to a work station in a manufacturing device on a mobile load receiving means, the method comprising:
gripping the workpiece with a mobile and robot-guided gripper tool;
clamping the workpiece in a defined position and orientation; and
supporting, stabilizing, and positioning the gripper tool, together with the gripped, clamped workpiece, at the work station in a stationary manner using an adjustable support device of a positioning and clamping system.

33. The method of claim 32, wherein the gripper tool is a geo-gripper tool.

34. The method of claim 32, further comprising:
removing the workpiece from the load receiving means using the gripper tool; and
clamping the workpiece.

35. The method of claim 32, further comprising:
placing the gripper tool, in an operating position of the gripper tool, onto the support device from a position above the support device; and
fixing the gripper tool to the support device.

36. The method of claim 32, wherein a plurality of different gripper tools are provided that are adapted for processing different workpieces, the method further comprising:
adjusting the support device in one or more axes and in an automatically controlled manner to thereby adapt the support device to the different gripper tools.

37. The method of claim 32, further comprising:
supplying the mobile load receiving means, together with the workpiece, on a transport means to the manufacturing device and the work station.
